(19) United States
(12) Patent Application Publication
(10) Pub. No.: US 2008/0179283 A1
(43) Pub. Date: Jul. 31, 2008

(54) PLASMA ETCHING METHOD AND PLASMA ETCHING APPARATUS

(75) Inventor: Hiroyuki SHIBAMURA, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/968,918

(22) Filed: Jan. 3, 2008

Related U.S. Application Data
(60) Provisional application No. 60/908,434, filed on Mar. 28, 2007.

(30) Foreign Application Priority Data
Jan. 31, 2007 (JP) 2007-021093

(51) Int. Cl. B44C 1/22; C23F 1/02

(52) U.S. Cl. 216/51; 156/345.29

(57) ABSTRACT

A plasma etching method includes accommodating a target substrate in a processing chamber; supplying a processing gas from a processing gas supplying mechanism disposed to face the target substrate and configured to be able to supply different processing gases to a central portion and a peripheral portion of the target substrate; and generating a plasma of the processing gas to perform a plasma etching on a lower organic resist film formed on the target substrate by using, as a mask, an intermediate layer made of an inorganic material and an upper photosensitive resist film that are formed on the lower organic resist film. As the processing gas, a gas containing CH₄ gas is supplied, and a flow rate of the CH₄ gas supplied to the peripheral portion is set to be higher than a flow rate of the CH₄ gas supplied to the central portion.

### FIELD OF THE INVENTION

The present invention relates to a plasma etching method and apparatus for etching a lower organic resist film formed on a target substrate by generating a plasma of a processing gas, by using as a mask an intermediate layer made of an inorganic material and an upper photosensitive resist film formed on the lower organic resist film.

### BACKGROUND OF THE INVENTION

Conventionally, in a manufacturing process for a semiconductor device, a plasma etching process is performed via a resist mask to form, e.g., an insulating film in a desired pattern. As for such plasma etching method, there is known a technique for performing micro-processing with high precision by employing a multilayer resist process.

With regard to the multilayer resist process, as a method for plasma etching a lower organic resist film by using, as a mask, an intermediate layer made of an inorganic material and an upper photosensitive resist film that are formed on the lower organic resist film, there is known a plasma etching method in which a gaseous mixture of oxygen gas (O₂) and methane gas (CH₄) is used as a processing gas, for example (see, for instance, Japanese Patent Laid-open Application No. 2002-93778).

In the above-mentioned plasma etching method, however, there are problems that a side etching is easily likely to occur at a sidewall portion and that a so-called bowing phenomenon is occurred, which results in openings having barrel-shaped cross sections. Moreover, on a single semiconductor wafer, etching profiles of, e.g., a central portion and a peripheral portion of the semiconductor wafer are different in shapes from each other.

### SUMMARY OF THE INVENTION

In view of the foregoing, the present invention provides a plasma etching method and apparatus capable of performing an improved plasma etching process by preventing an occurrence of a side etching and a bowing phenomenon, while improving an in-plane uniformity of etching profiles.

In accordance with a first aspect of the present invention, there is provided a plasma etching method including: accommodating a target substrate in a processing chamber; supplying a processing gas from a processing gas supplying mechanism disposed to face the target substrate and configured to supply different processing gases to a central portion and a peripheral portion of the target substrate; generating a plasma of the processing gas and plasma etching a lower organic resist film formed on the target substrate by using, as a mask, an intermediate layer made of an inorganic material and an upper photosensitive resist film that are formed on the lower organic resist film, wherein a gas containing a CH₄ gas is supplied as the processing gas, and a flow rate of the CH₄ gas supplied to the peripheral portion is set to be higher than a flow rate of the CH₄ gas supplied to the central portion.

It is preferable that the processing gas contains O₂ gas.

The processing gas may further contain Ar gas.

In accordance with a second aspect of the present invention, there is provided a plasma etching method including: accommodating a target substrate in a processing chamber; supplying a processing gas from a processing gas supplying mechanism disposed to face the target substrate and configured to supply different processing gases to a central portion and a peripheral portion of the target substrate; generating a plasma of the processing gas and plasma etching a lower organic resist film formed on the target substrate by using, as a mask, an intermediate layer made of an inorganic material and an upper photosensitive resist film that are formed on the lower organic resist film, wherein a first processing gas containing an O₂ gas but not containing a CH₄ gas is supplied to the central portion, and a second processing gas containing an O₂ gas and a CH₄ gas is supplied to the peripheral portion.

It is preferable that a ratio of a total O₂ gas flow rate (a sum of an O₂ gas flow rate of the first processing gas and an O₂ gas flow rate of the second processing gas) to a flow rate of the CH₄ gas of the second processing gas, i.e., a ratio of (the total O₂ gas flow rate)/(a CH₄ gas flow rate), is about 0.8 to 1.0.

The first and the second processing gas may contain Ar gas.

In accordance with a third aspect of the present invention, there is provided a plasma etching method including: accommodating a target substrate in a processing chamber; supplying a processing gas from a processing gas supplying mechanism disposed to face the target substrate and configured to supply different processing gases to a central portion and a peripheral portion of the target substrate; generating a plasma of the processing gas and plasma etching a lower organic resist film formed on the target substrate by using, as a mask, an intermediate layer made of an inorganic material and an upper photosensitive resist film that are formed on the lower organic resist film, wherein a gas containing a CO gas is supplied as the processing gas, and a flow rate of the CO gas supplied to the peripheral portion is set to be higher than a flow rate of the CH₄ gas supplied to the central portion.

It is preferable that the processing gas contains O₂ gas.

The processing gas may further contain Ar gas.

In accordance with a fourth aspect of the present invention, there is provided a plasma etching method including: accommodating a target substrate in a processing chamber; supplying a processing gas from a processing gas supplying mechanism disposed to face the target substrate and configured to supply different processing gases to a central portion and a peripheral portion of the target substrate; generating a plasma of the processing gas and plasma etching a lower organic resist film formed on the target substrate by using, as a mask, an intermediate layer made of an inorganic material and an upper photosensitive resist film that are formed on the lower organic resist film, wherein a first processing gas containing an O₂ gas but not containing a CO gas is supplied to the central portion, and a second processing gas containing an O₂ gas and a CO gas is supplied to the peripheral portion.

It is preferable that a ratio of a total O₂ gas flow rate (a sum of an O₂ gas flow rate of the first processing gas and an O₂ gas flow rate of the second processing gas) to a flow rate of the CO gas, i.e., a ratio of (the total O₂ gas flow rate)/(the CO flow rate), is about 0.8 to 1.0.

Further, the first and the second processing gas may contain Ar gas.

In accordance with a fifth aspect of the present invention, there is provided a plasma etching apparatus including: a processing chamber for accommodating a target substrate therein; a processing gas supply unit for supplying a processing gas into the processing chamber from a processing gas supplying mechanism disposed to face the target substrate and configured to be capable of supplying different processing gases to a central portion and a peripheral portion of the semiconductor wafer; a plasma generating unit for generating a plasma of the processing gas supplied from the processing gas supply unit and processing the target substrate by the plasma; and a control unit for controlling the plasma etching method described in the first aspect of the invention to be carried out in the processing chamber.

In accordance with a sixth aspect of the present invention, there is provided a computer-executable control program stored in a storage medium for controlling, when executed, a plasma etching apparatus to perform the plasma etching method described above.

In accordance with a seventh aspect of the present invention, there is provided a computer-readable storage medium for storing therein a computer executable control program, wherein the control program controls a plasma etching apparatus to perform the plasma etching method described above.

In accordance with the present invention, an occurrence of a side etching and a bowing phenomenon is prevented so that an improved plasma etching process is performed and, at the same time, an in-plane uniformity of etching profiles is improved.

### BRIEF DESCRIPTION OF THE DRAWINGS

The objects and features of the present invention will become apparent from the following description of embodiments given in conjunction with the accompanying drawings, in which:

FIGS. 1A to 1C provide cross sectional views of a semiconductor wafer to which a plasma etching method in accordance with an embodiment of the present invention is applied; and

FIG. 2 is a schematic configuration view of a plasma etching apparatus in accordance with an embodiment of the present invention.

### DETAILED DESCRIPTION OF THE EMBODIMENTS

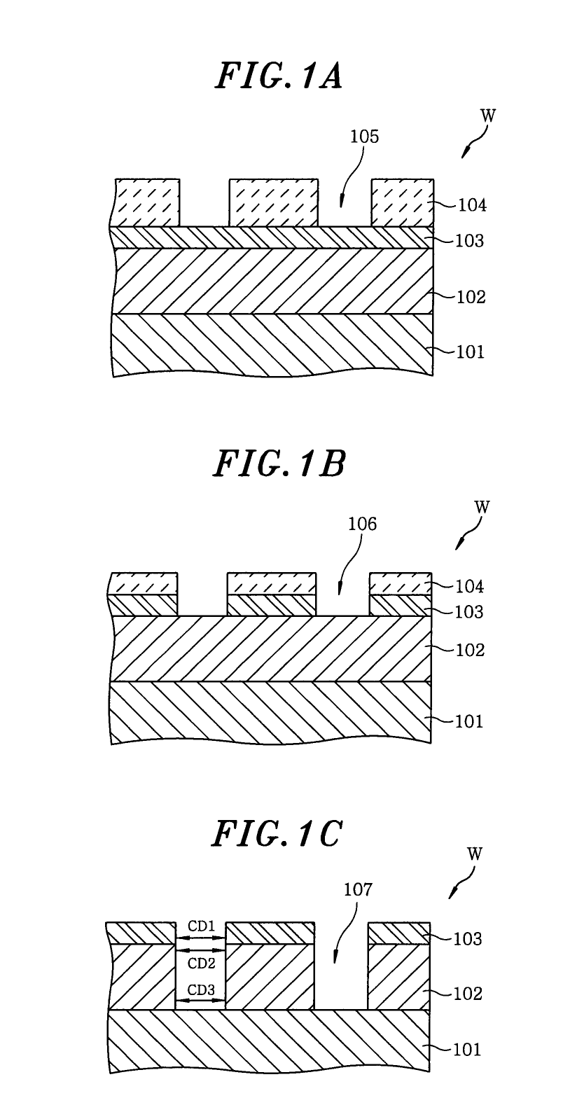

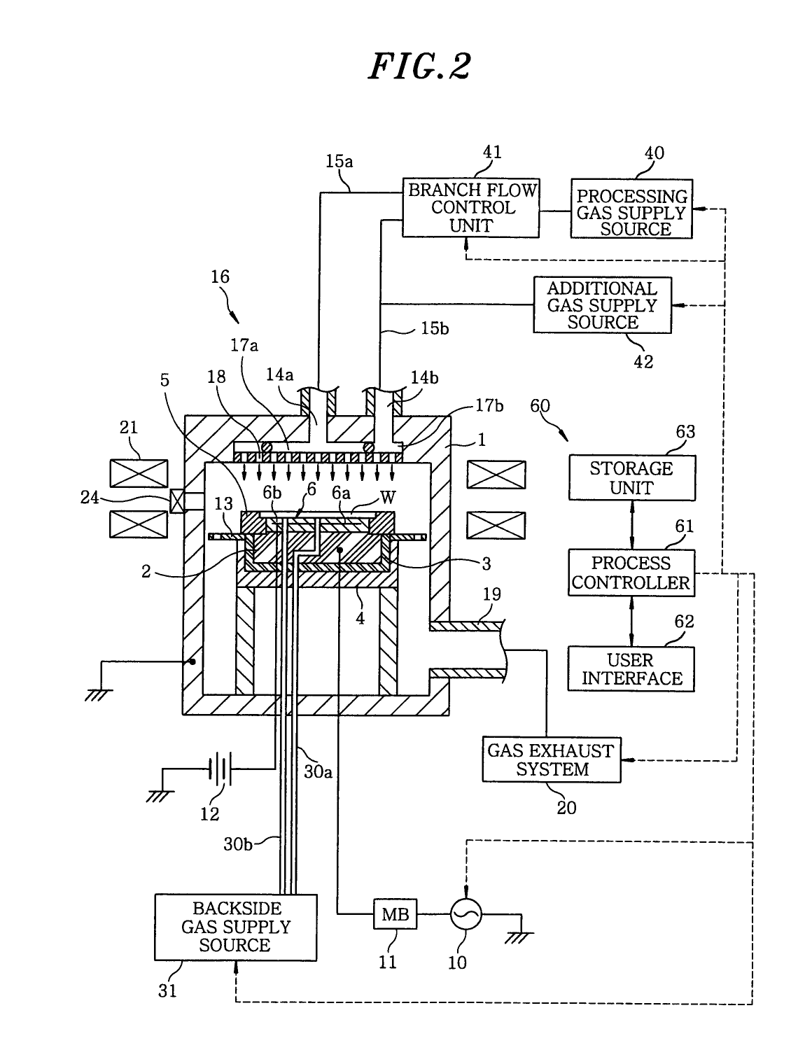

Hereinafter, embodiments of the present invention will be described with reference to the accompanying drawings. FIG. 1A to 1C are an enlarged cross sectional view of a semiconductor wafer as a target substrate on which a plasma etching method in accordance with an embodiment of the present invention is performed. FIG. 2 illustrates a plasma etching apparatus in accordance with an embodiment of the present invention. First, the configuration of the plasma etching apparatus will be explained in connection with FIG. 2.

The plasma etching apparatus includes a processing chamber 1 airtightly configured and electrically grounded. The processing chamber 1 has a cylindrical shape and is made of, e.g., aluminum. Disposed in the processing chamber 1 is a mounting table 2 for horizontally sustaining thereon a semiconductor wafer W, which is a target substrate. The mounting table 2, which is made of, e.g., aluminum, is supported by a conductive support 4 via an insulating plate 3. Further, a focus ring 5 formed of, e.g., single-crystalline silicon is disposed on the peripheral portion of the top surface of the mounting table 2.

An RF power supply 10 is connected to the mounting table 2 via a matching box (MB) 11, and a high frequency power of a specific frequency (e.g., about 13.56 MHz) is supplied from the RF power supply 10 to the mounting table 2. A shower head 16 is disposed above the mounting table 2, while facing the mounting table 2 in parallel. The shower head 16 is grounded. Accordingly, the mounting table 2 and the shower head 16 are configured to function as a pair of electrodes.

An electrostatic chuck 6 for electrostatically attracting and holding the semiconductor wafer W is provided at an upper portion of the mounting table 2. The electrostatic chuck 6 includes an insulator 6b and an electrode 6a embedded therein, and the electrode 6a is connected to a DC power supply 12. The semiconductor wafer W is attracted and held by a Coulomb force generated by applying a DC voltage to the electrode 6a from the DC power supply 12.

A coolant path (not shown) is formed inside the mounting table 2, and by circulating a proper coolant through the coolant path, the temperature of the mounting table 2 is controlled to a specific temperature level. Further, backside gas supply channels 30a and 30b for supplying a cold heat transfer gas (backside gas) such as helium gas or the like to the rear side of the semiconductor wafer W are formed through the mounting table 2 and so forth. These backside gas supply channels 30a and 30b are connected to a backside gas (helium gas) supply source 31.

The backside gas supply channel 30a supplies the backside gas to a central portion of the semiconductor wafer W, while the backside gas supply channel 30b supplies the backside gas to a peripheral portion of the semiconductor wafer W. Moreover, it is possible to separately control the pressures of the backsides gas at the central portion and the peripheral portion of the semiconductor wafer W. With such configurations, the semiconductor wafer W held by the electrostatic chuck 6 on the top surface of the mounting table 2 can be controlled to a desired temperature.

Further, a gas exhaust ring 13 is provided outside of the focus ring 5. The gas exhaust ring 13 is electrically connected with the processing chamber 1 via the support 4.

The shower head 16 is disposed at the ceiling portion of the processing chamber 1 to serve as a processing gas supplying mechanism. The shower head 16 is provided with a number of gas injection openings 18 at its lower surface and has two gas inlets at an upper portion thereof: one is a central gas inlet 14a and the other is a peripheral gas inlet 14b. Further, the shower head 16 has a space therein, and the space is divided into a central space 17a and a peripheral space 17b surrounding the central space 17a, wherein the central space 17a and the peripheral space 17b are airtightly separated from each other.

A central gas supply line 15a is connected to the central gas inlet 14a, and a peripheral gas supply line 15b is connected to the peripheral gas inlet 14b. A processing gas from a processing gas supply source 40 is introduced into the central gas supply line 15a via a branch flow control unit 41. Further, the processing gas from the processing gas supply source 40 is also introduced into the peripheral gas supply line 15b via the branch flow control unit 41, and an additional gas from an additional gas supply source 42 is also introduced into the peripheral gas supply line 15b. In the present embodiment, single gas of O₂ or a gaseous mixture of O₂ and Ar is supplied from the processing gas supply source 40, and a CH₄ gas or a CO gas is supplied from the additional gas supply source 42. The branch flow control unit 41 allows the processing gas from the processing gas supply source 40 to branch off to flow into the central gas supply line 15a and the peripheral gas supply line 15b at a desired flow rate ratio.

The processing gas supplied to the central space 17a via the central gas supply line 15a and the central gas inlet 14a is injected toward the central region of the semiconductor wafer W through the gas injection openings 18. Further, the processing gas containing the additional gas supplied to the peripheral space 17b via the peripheral gas supply line 15b and the peripheral gas inlet 14b is injected toward the peripheral region of the semiconductor wafer W through the gas injection openings 18. With such configurations, it is possible to supply different processing gases (depending on presence or absence of the additional gas) for the central portion and the peripheral portion of the semiconductor wafer w at different flow rates.

A gas outlet port 19 is formed at a lower portion of the processing chamber 1, and a gas exhaust system 20 is connected to the gas outlet port 19. By operating a vacuum pump provided in the gas exhaust system 20, the processing chamber 1 can be depressurized to a specific vacuum level. Further, a gate valve 24 for opening and closing a loading/unloading port for the wafer W is provided at a sidewall of the processing chamber 1.

Concentrically disposed around the processing chamber 1 are ring magnets 21 which serve to form a magnetic field in a space between the mounting table 2 and the shower head 16. The ring magnets 21 can be rotated by a rotation mechanism (not shown) such as a motor.

The general operation of the plasma etching apparatus having the above-configuration is controlled by a control unit 60. The control unit 60 includes a process controller 61 having a CPU and controlling each part of the plasma etching apparatus; a user interface 62; and a storage unit 63.

The user interface 62 includes a keyboard for a process manager to input a command to operate the plasma etching apparatus, a display for showing an operational status of the plasma etching apparatus, and the like.

The storage unit 63 stores therein, e.g., recipes including processing condition data and the like and control programs (software) to be used in realizing various processes performed in the plasma etching apparatus under the control of the process controller 61. When receiving a command from the user interface 62, the process controller 61 retrieves necessary recipe from the storage unit 63 and executes it. Accordingly, a desired process is performed in the plasma etching apparatus under the control of the process controller 61. The recipes including the processing condition data and the control programs can be retrieved from a computer-readable storage medium (e.g., a hard disk, a CD, a flexible disk, a semiconductor memory, and the like), or can be used on-line by being transmitted from another apparatus via, e.g., a dedicated line, whenever necessary.

Below, there will be explained a sequence for plasma etching a lower organic resist film and the like formed on a semiconductor wafer W by using the plasma etching apparatus configured as described above. First, the gate valve 24 is opened, and a semiconductor wafer W is loaded from a load lock chamber (not shown) into the processing chamber 1 by a transport robot (not shown) or the like to be mounted on the mounting table 2. Then, the transport robot is retreated from the processing chamber 1, and the gate valve 24 is closed. Subsequently, the processing chamber 1 is evacuated via the gas outlet port 19 by the vacuum pump of the gas exhaust system 20.

If the inside of the processing chamber 1 reaches a specific vacuum level, a processing gas (etching gas) is supplied from the processing gas supply source 40 and the additional gas supply source 42 into the processing chamber 1. While maintaining the internal pressure of the processing chamber 1 at a specific pressure level, e.g., about 2.00 Pa (15 mTorr), a high frequency power of e.g., about 100 to 5000 W, having a frequency of, e.g., about 13.56 MHz is supplied to the mounting table 2 from the RF power supply 10. At this time, a specific DC voltage is applied from the DC power supply 12 to the electrode Ga of the electrostatic chuck 6, whereby the semiconductor wafer W is attracted and held by the electrostatic chuck 6 by a Coulomb force.

By applying the high frequency power to the mounting table 2 as described above, an electric field is formed between the shower head 16 serving as an upper electrode and the mounting table 2 serving as a lower electrode. Meanwhile, since a horizontal magnetic field is formed at the upper portion of the processing chamber 1 by the ring magnets 21, electrons are made to drift in the processing space where the semiconductor wafer W is located, which in turn causes a magnetron discharge. As a result of the magnetron discharge, a plasma of the processing gas is generated, and the lower organic resist film and the like formed on the semiconductor wafer W is etched by the plasma.

After the above-described etching process is finished, the supply of the high frequency power and the processing gas is stopped, and the semiconductor wafer W is unloaded from the processing chamber 1 in a reverse sequence to that described above.

Now, a plasma etching method in accordance with an embodiment of the present invention will be described with reference to FIGS. 1A to 1C. FIGS. 1A to 1C provide enlarged configuration views of major parts of a semiconductor wafer W which is used as a target substrate in the embodiment.

In FIG. 1A, reference numeral 101 denotes a base layer which is a final target to be etched, and it is a SiN film in this embodiment. On the SiN film 101, there is formed a lower organic resist film 102 made of, e.g., amorphous carbon and the like. Further, on the lower organic resist film 120, there is formed an intermediate layer made of an inorganic material, e.g., a SiO₂ film 103. On the SiO₂ film, an upper photosensitive resist film 104 is formed. The upper photosensitive resist film 104 is patterned through a photolithographic process to have patterned openings 105 of a specific shape. This upper photosensitive resist film 104 is formed thinner than the lower organic resist film 102.

The semiconductor wafer W is loaded into the processing chamber 1 of the plasma etching apparatus shown in FIG. 2 and is mounted on the mounting table 2. Then, from the state illustrated in FIG. 1A, the SiO₂ film 103 is plasma etched through the upper photosensitive resist film 104, thereby forming openings 106 in the SiO₂ film 103, as shown in FIG. 1B. This plasma etching process is performed by using a processing gas of, e.g., O₂/CF₄.

Thereafter, from the state shown in FIG. 1B, the lower organic resist film 102 is plasma etched by using the SiO₂ film 103 and the upper photosensitive resist film 104 as a mask, thereby forming openings 107 in the lower organic resist film 102. In this plasma etching process, an oxygen-containing gas such as a single gas of O₂ or a gaseous mixture of O₂/Ar is used as a processing gas to be supplied to the central portion, and a gaseous mixture made up of the oxygen-containing gas such as the O₂ single gas or the gaseous mixture of O₂/Ar and CH₄ or CO gas added thereto is used as a processing gas to be supplied to the peripheral portion.

Here, it is possible to use the gaseous mixture containing CH₄ or CO as the processing gas to be supplied to the central portion as well. In such case, however, supply amount of the CH₄ to the peripheral portion needs to be larger than to the central portion in order to improve an in-plane uniformity of etching profiles to be described later. Further, during the plasma etching process of the lower organic resist film 102, the upper photosensitive resist film 104 is also etched, so that the upper photosensitive resist film 104 is removed after this plasma etching process is completed, as shown in FIG. 1C.

As Test Example 1, by using the plasma etching apparatus illustrated in FIG. 2, the above-described plasma etching process was performed on a semiconductor wafer having the same structure as that shown in FIG. 1A in accordance with a processing recipe specified below.

The processing recipes of Test Example 1 and Test Example 2 to be described later are read from the storage unit 63 of the control unit 60 and inputted to the process controller 61. The process controller 61 controls each part of the plasma etching apparatus based on the control program, so that the plasma etching process is performed according to the retrieved processing recipes as follows:

(Processing Conditions for Plasma Etching of SiO₂ Film)

processing gas (central portion): O₂/CF₄=15/75 sccm;

processing gas (peripheral portion): O₂/CF₄=15/75 sccm;

pressure: 10.64 Pa (80 mTorr);

high frequency power: 1500 W;

temperature (ceiling and sidewall of chamber/mounting table): 60/20° C.;

backside gas pressure (central/peripheral portion): 933/3333 Pa (7/25 Torr);

processing time: 15 seconds

(Processing Conditions for Plasma Etching of Lower Organic Resist Film)

processing gas (central portion): O₂/Ar=45/75 sccm;

processing gas (peripheral portion): O₂/Ar/CH₄=45/75/100 sccm;

pressure: 2.00 Pa (15 mTorr);

high frequency power: 500 W;

temperature (ceiling and sidewall of chamber/mounting table): 60/20° C.;

backside gas pressure (central/peripheral portion): 933/3333 Pa (7/25 Torr);

processing time: 122 seconds.

In the above Test Example 1, critical dimensions (CD) of openings were measured. A CD of a bottom portion of the SiO₂ film (CD1 in FIG. 1C), a CD of a top portion of the lower organic resist film (CD2 in FIG. 1C) and a CD of a bottom portion of the lower organic resist film (CD3 in FIG. 1C) were found to be as follows at the central portion and the peripheral portion of the semiconductor wafer W:

CD1/CD2/CD3 (central portion)=66/65/66 nm;

CD1/CD2/CD3 (peripheral portion)=65/64/65 nm.

From the above results, the maximum difference between the CD1, the CD2 and the CD3 was 1 nm both at the central portion and the peripheral portion. Further, the maximum difference in CD1, CD2, and CD3 between the central portion and the peripheral portion was 1 nm.

As Test Example 2, plasma etching of the lower organic resist film was performed under the following processing conditions, and the plasma processing conditions for the SiO₂ film were identical with those in Test Example 1:

processing gas (central portion): O₂/Ar=90/150 sccm;

processing gas (peripheral portion): O₂/Ar/CO=90/150/200 sccm;

pressure: 4.00 Pa (30 mTorr);

high frequency power: 500 W

temperature (ceiling and sidewall of chamber/mounting table): 60/20° C.;

backside gas pressure (central/peripheral portion): 933/3333 Pa (7/25 Torr);

processing time: 57 seconds.

In the above Test Example 2, CD measurement results were as follow:

CD1/CD2/CD3 (central portion)=65/62/62 nm;

CD1/CD2/CD3 (peripheral portion)=64/61/61 nm.

From the above results, the maximum difference between the CD1, the CD2 and the CD3 was 3 nm both at the central portion and the peripheral portion. Further, the maximum difference in CD1, CD2, and CD3 between the central portion and the peripheral portion was 1 nm.

As a comparative example, a plasma etching was performed on the lower organic resist film under the following processing conditions in which CH₄ or CO was not added, and the plasma etching conditions for the SiO₂ film were identical with those for Test Examples 1 and 2:

processing gas (central portion): O₂/Ar=45/75 sccm;

processing gas (peripheral portion): O₂/Ar=45/75 sccm;

pressure: 2.00 Pa (15 mTorr);

high frequency power: 500 W

temperature (ceiling and sidewall of chamber/mounting table): 60/20° C.;

backside gas pressure (central/peripheral portion): 933/3333 Pa (7/25 Torr);

processing time: 60 seconds.

In the above comparative example, CD measurement results were as follows:

CD1/CD2/CD3 (central portion)=63/58/63 nm;

CD1/CD2/CD3 (Peripheral portion)=61/56/60 nm.

From the above results, the maximum difference between the CD1, the CD2, and the CD3 was 5 nm both at the central portion and the peripheral portion. Further, the maximum difference in CD1, CD2, and CD3 between the central portion and the peripheral portion was 3 nm.

The CD measurement results of Test Example 1, Test Example 2 and the comparative example are provided in Table 1.

TABLE 1

| | Test Example 1 | | | | Test Example 2 | | | | Comparative Example | | | |
|---|---|---|---|---|---|---|---|---|---|---|---|---|
| | CD1 | CD2 | CD3 | Diff. | CD1 | CD2 | CD3 | Diff. | CD1 | CD2 | CD3 | Diff. |
| Center | 66 | 65 | 66 | 1 | 65 | 62 | 62 | 3 | 63 | 58 | 63 | 5 |
| Periphery | 65 | 64 | 65 | 1 | 64 | 61 | 61 | 3 | 61 | 56 | 60 | 5 |
| Diff. | 1 | 1 | 1 | | 1 | 1 | 1 | | 2 | 2 | 3 | |

As described above, in Test Examples 1 and 2, the differences between the CD1, the CD2 and the CD3 both at the central portion and the peripheral portion of the semiconductor wafer W can be reduced in comparison with the comparative example. In other words, in Test Examples 1 and 2, a side etching is suppressed, and the opening can be formed to have a substantially vertical sidewall with a reduced bowing tendency.

Further, since the differences in CD1, CD2, and CD3 between the central portion and the peripheral portion of the semiconductor wafer W are reduced, an etching process can be performed with high in-plane uniformity, thus reducing the difference in etching profiles in the wafer surface.

In Test Example 1, the plasma etching was performed on the lower organic resist film while varying a ratio of a total O₂ flow rate (the sum of an O₂ flow rate at the central portion and an O₂ flow rate at the peripheral portion) to a flow rate of CH₄ i.e., (total O₂ flow rate)/(CH₄ flow rate), and resultant etching profiles were observed. As a result, when a ratio of the CH₄ flow rate to the total O₂ flow rate was small as in the case where (total O₂ flow rate)/(CH₄ flow rate) was set to be, e.g., 180/10 or 180/25, the effect of improving the etching profiles was insufficient. In order to obtain the effect of improving the etching profiles sufficiently, the flow rate of CH₄ needed to be increased such that the flow rate of CH₄ is substantially equivalent to the total flow rate of O₂ (e.g., (total O₂ flow rate)/(CH₄ flow rate)=90/100). Accordingly, it is preferable to set the ratio of the total O₂ flow rate/the CH₄ flow rate to be about 0.8 to 1.0.

Further, in Test Example 2, the plasma etching was performed on the lower organic resist film while varying a ratio of a total flow rate of O₂ (the sum of an O₂ flow rate at the central portion and an O₂ flow rate at the peripheral portion) to a flow rate of CO, i.e., (total O₂ flow rate)/(CO flow rate), and resultant etching profiles were observed. As a result, when a ratio of the CO flow rate to the total flow rate of O₂ was small as in the case where (total O₂ flow rate)/(CO flow rate) was set to be, e.g., 180/50, the effect of improving the etching profiles was insufficient. In order to obtain the effect of improving the etching profiles sufficiently, the flow rate of CO needed to be increased such that the flow rate of CO is substantially equivalent to the total flow rate of O₂ (e.g., (total O₂ flow rate)/(CO flow rate)=180/200).

However, an adverse effect was observed when the flow rate of CO was excessively high (e.g., as in the case where (total O₂ flow rate)/(CO flow rate) was set to be 180/400). Accordingly, it is preferable to set the ratio of the total O₂ flow rate to the CO flow rate to be about 0.8 to 1.0.

Though Test Examples 1 and 2 have been described for the case of using the processing gas containing Ar for the plasma etching of the lower organic resist film, the Ar gas is not essential, and a processing gas containing O₂ gas can be used. For example, a plasma etching was executed on the lower resist film under the following processing conditions:

processing gas (central portion): O₂=45 scam;

processing gas (peripheral portion): O₂/CH₄=45/100 sccm.

In this case, substantially same etching profiles and in-plane uniformity as those of the example 1 were obtained.

Meanwhile, the flow rate of CH₄ or CO at the peripheral portion is required to be higher than that at the central portion. For example, the CH₄ flow rate at the central portion was set to be same as that at the peripheral portion as follows:

processing gas (central portion): O₂/CH₄=45/50 scam;

processing gas (peripheral portion): O₂/CH₄=45/50 sccm.

In this case, etching profiles were different at the central portion and the peripheral portion of the semiconductor wafer W so that uniform etching profiles could not be obtained. Furthermore, at the central portion of the semiconductor wafer, etch stop occurred, resulting in a failure to obtain desired etching profiles.

As described above, in accordance with the embodiment of the present invention, by suppressing a side etching, an occurrence of a bowing phenomenon can be prevented and an in-plane uniformity of etching profiles can be improved. Accordingly, an improved plasma etching process can be performed in comparison with conventional cases.

Here, it is to be noted that the present invention is not limited to the above embodiment but can be modified in various ways. For example, the plasma etching apparatus is not limited to the parallel plate type apparatus shown in FIG. 2 in which a single high frequency power is applied to the lower electrode, but various other plasma etching apparatuses can be used. For example, the plasma etching apparatus may be of a type in which dual high frequency powers are applied to the upper and the lower electrode separately or of a type in which dual high frequency powers are applied to the lower electrode only. Moreover, though the embodiment has been described for the example of introducing a processing gas through dual channels, such as the central portion and the peripheral portion of the wafer, but it is also possible that triple or more channels may be used for introducing a processing gas.

While the invention has been shown and described with respect to the embodiments, it will be understood by those skilled in the art that various changes and modifications may be made without departing from the scope of the invention as defined in the following claims.

What is claimed is:

1. A plasma etching method comprising:
accommodating a target substrate in a processing chamber;
supplying a processing gas from a processing gas supplying mechanism disposed to face the target substrate and configured to be able to supply different processing gases to a central portion and a peripheral portion of the target substrate; and
generating a plasma of the processing gas to perform a plasma etching on a lower organic resist film formed on the target substrate by using, as a mask, an intermediate layer made of an inorganic material and an upper photosensitive resist film that are formed on the lower organic resist film,
wherein a gas containing CH₄ gas is supplied as the processing gas, and a flow rate of the CH₄ gas supplied to the peripheral portion is set to be higher than a flow rate of the CH₄ gas supplied to the central portion.

2. The plasma etching method of claim 1, wherein the processing gas contains O₂ gas.

3. The plasma etching method of claim 2, wherein the processing gas contains Ar gas.

4. A plasma etching method comprising:
accommodating a target substrate in a processing chamber;
supplying a processing gas from a processing gas supplying mechanism disposed to face the target substrate and configured to be able to supply different processing gases to a central portion and a peripheral portion of the target substrate;
generating a plasma of the processing gas to perform a plasma etching on a lower organic resist film formed on the target substrate by using, as a mask, an intermediate layer made of an inorganic material and an upper photosensitive resist film that are formed on the lower organic resist film,
wherein a first processing gas containing O₂ gas but not containing CH₄ gas is supplied to the central portion, and a second processing gas containing O₂ gas and CH₄ gas is supplied to the peripheral portion.

5. The plasma etching method of claim 4, wherein a ratio of a total O₂ gas flow rate (a sum of an O₂ gas flow rate of the first processing gas and an O₂ gas flow rate of the second processing gas) to a flow rate of the CH₄ gas of the second processing gas, i.e., a ratio of (total O₂ gas flow rate)/(CH₄ gas flow rate), is about 0.8 to 1.0.

6. The plasma etching method of claim 4, wherein the first and the second processing gas contain Ar gas.

7. A plasma etching method comprising:
accommodating a target substrate in a processing chamber;
supplying a processing gas from a processing gas supplying mechanism disposed to face the target substrate and configured to be able to supply different processing gases to a central portion and a peripheral portion of the target substrate;
generating a plasma of the processing gas to perform a plasma etching on a lower organic resist film formed on the target substrate by using, as a mask, an intermediate layer made of an inorganic material and an upper photosensitive resist film that are formed on the lower organic resist film,
wherein a gas containing CO gas is supplied as the processing gas, and a flow rate of the CO gas supplied to the peripheral portion is set to be higher than a flow rate of the CO gas supplied to the central portion.

8. The plasma etching method of claim 7, wherein the processing gas contains O₂ gas.

9. The plasma etching method of claim 8, wherein the processing gas contains Ar gas.

10. A plasma etching method comprising:
accommodating a target substrate in a processing chamber;
supplying a processing gas from a processing gas supplying mechanism disposed to face the target substrate and configured to be able to supply different processing gases to a central portion and a peripheral portion of the target substrate;
generating a plasma of the processing gas to perform a plasma etching on a lower organic resist film formed on the target substrate by using, as a mask, an intermediate layer made of an inorganic material and an upper photosensitive resist film that are formed on the lower organic resist film,
wherein a first processing gas containing O₂ gas but not containing CO gas is supplied to the central portion, and a second processing gas containing O₂ gas and CO gas is supplied to the peripheral portion.

11. The plasma etching method of claim 10, wherein a ratio of a total O₂ gas flow rate (a sum of an O₂ gas flow rate of the first processing gas and an O₂ gas flow rate of the second processing gas) to a flow rate of the CO gas of the second processing gas, i.e., a ratio of (total O₂ gas flow rate)/(CO gas flow rate), is about 0.8 to 1.0.

12. The plasma etching method of claim 10, wherein the first and the second processing gas contain Ar gas.

13. A plasma etching apparatus comprising:
a processing chamber for accommodating a target substrate therein;
a processing gas supply unit for supplying a processing gas into the processing chamber from a processing gas supplying mechanism disposed to face the target substrate and configured to be able to supply different processing gases to a central portion and a peripheral portion of the semiconductor wafer;
a plasma generating unit for generating a plasma of the processing gas supplied from the processing gas supply unit and processing the target substrate by the plasma; and
a control unit for controlling the plasma etching apparatus to execute the plasma etching method described in claim 1 in the processing chamber.
